(19) United States
(12) Patent Application Publication
(10) Pub. No.: US 2018/0012260 A1
(43) Pub. Date: Jan. 11, 2018

(54) Motion Activated Advertising Apparatus With Wireless Device Connectivity

(71) Applicant: Synergy Media, LLC, Winston-Salem, NC (US)

(72) Inventor: H. Christopher Bazos, Pickering (CA)

(73) Assignee: Synergy Media, LLC, Winston-Salem, NC (US)

(21) Appl. No.: 15/643,637

(22) Filed: Jul. 7, 2017

Related U.S. Application Data
(60) Provisional application No. 62/360,078, filed on Jul. 8, 2016.

(51) Int. Cl. G06Q 30/02; G09F 13/00; G09F 13/18; G09F 13/22; H04W 8/00; H04B 1/02

(52) U.S. Cl. CPC G06Q 30/0267; G09F 13/18; G09F 13/22; G09F 13/005; G09F 2013/1845; G09F 2013/1804; G09F 2013/1881; H04B 1/02; H04W 8/005; G09F 2013/1831

(57) ABSTRACT

An advertising apparatus is capable of motion sensitive illumination and 180° viewing, wherein the advertising apparatus comprises: a top piece; a bottom piece; a back piece adapted for mounting the advertising apparatus to an external structure; a front display piece adapted for displaying graphics, wherein the front display piece has a convex shape, and wherein the top piece, the bottom piece, the back piece, and the front display piece are mechanically coupled together; an illumination source for illuminating the front display piece, wherein the front display piece is illuminated when the illumination source is active; a multifaceted motion sensor for detecting motion of a person, wherein the multifaceted motion sensor is configured to trigger the illumination source when said person's heat moves across at least two facets of the multifaceted motion sensor; a wireless transmitter, wherein the wireless transmitter has a transmission radius, wherein the wireless transmitter is capable of detecting a person carrying a wireless-enabled device when said person passes within the transmission radius of the wireless transmitter, and wherein the wireless transmitter delivers advertising and marketing content to said wireless-enabled device; and a power source, wherein the illumination source, the motion sensor, and the wireless transmitter are coupled to the power source.

### CROSS REFERENCE TO RELATED APPLICATIONS

This application claims priority to U.S. Provisional Patent Application No. 62/360,078, filed Jul. 8, 2016.

### FIELD OF THE INVENTION

The present disclosure relates generally to an apparatus for a motion-sensitive advertisement that activates when a potential customer approaches or when a personal wireless device is detected within a certain radius of the apparatus.

### BACKGROUND OF THE INVENTION

The broad field of retail advertising has gone through many changes from the time of posting a printed flyer inside a store window to the contemporary development of elaborate displays that are situated in the middle of a store's floor space that are designed to stimulate interest and promote unplanned purchases of the product. Retail advertising is geared to drive customers to consummate the purchase and/or is placed at the point of purchase to assure that the chosen product is kept foremost in the consumer's mind. This medium relies on a mixture of media delivered both outside and inside the retail environment. Examples of media that are delivered inside of retail environment are: paper posters placed in windows of stores; examples of products on sale placed in the windows of stores; elaborate point-of-purchase displays that stand in the middle of stores' floor space; and/or highlighting the promoted product. It is a goal of advertisers to make their products clearly visible to potential customers and to attract the attention of the potential customers. This is difficult to do, especially in a retail environment where potential customers are bombarded by advertisements and images of products all around them.

Thus, it would be advantageous to create an advertising apparatus which draws the attention of a potential customer, is targeted to each customer's product preferences, buying habits, recent purchases, and recent store visits, is cost effective, and is energy conscious. These advantages are met by the present disclosure.

### SUMMARY OF THE DISCLOSURE

According to one embodiment, the invention comprises an advertising apparatus capable of motion sensitive illumination and capable of 180° viewing from a consumer. The advertising apparatus comprises a top piece; a bottom piece; a back piece adapted for mounting the advertising apparatus to an external structure; and a front display piece adapted for displaying graphics present on the front display surface, wherein the front display piece has a convex shape and wherein the top piece, the bottom piece, the back piece, and the front display surface piece are mechanically coupled together to form the assembled advertising apparatus. The advertising apparatus further comprises an illumination source for illuminating the front display piece; a multifaceted motion sensor for detecting motion of a potential customer, wherein the multifaceted motion sensor is configured to trigger the apparatus when a customer's heat moves across at least two facets of the multifaceted motion sensor; a wireless transmitter, wherein the wireless transmitter has a transmission radius, is capable of detecting a person carrying a wireless-enabled device when said person passes within the transmission radius of the wireless transmitter, and delivers advertising and marketing content to said person's wireless-enabled device; and a power source to power the advertising apparatus, wherein the illumination source, the motion sensor, and the wireless transmitter are coupled to the power source.

In certain embodiments, the invention further comprises a back piece with suction cups attached thereto for mounting to an external surface.

In certain embodiments, the invention further comprises a back piece with an attached clamp for mounting to an external structure.

In certain embodiments, the invention further comprises a bottom piece that defines a leading edge, wherein the leading edge is mechanically coupled to the front display piece.

In certain embodiments, the invention further comprises an illumination source supported by the bottom piece and positioned to edge illuminate the front display piece.

In certain embodiments, the invention further comprises a power switch coupled to the power source to power the advertising apparatus up or down.

In certain embodiments, the invention further comprises at least one battery as the power source.

In certain embodiments, the invention further comprises an internal battery compartment which is defined by the back piece and a removable cover and which receives at least one battery, wherein the back piece and removable cover conceal the battery compartment.

In certain embodiments, the invention further comprises a charging and/or AC/DC adaptor plug, for charging and/or powering the advertising apparatus.

In certain embodiments, the invention further comprises an illumination source further comprising a set of light emitting diodes (LED) placed proximate to an edge of the bottom piece and capable of edge illumination of the front display piece.

In certain embodiments, the invention further comprises a controller for the illumination source coupled to the power supply and the illumination source.

In certain embodiments, the invention further comprises an illumination source further comprising a set of light emitting diodes (LED) wherein the LEDs are present in at least one LED strip.

In certain embodiments, the invention further comprises an illumination source further comprising two LED strips of twelve LEDs each.

In certain embodiments, the invention further comprises an electroluminescence (EL) illumination source.

In certain embodiments, the invention further comprises a front display piece that is an EL light source.

In certain embodiments, the invention further comprises a circuit board comprising a circuit, wherein the illumination source, a controller for the illumination source, the motion sensor, and the power source are coupled to the circuit.

In certain embodiments, the invention further comprises a circuit configured to have a cycled on period and a forced off period, wherein the cycled on period is from about 1 second to about 120 seconds and the forced off period is from about 1 second to about 120 seconds.

In certain embodiments, the invention has a cycled on period of about 7 seconds and a forced off period of about 20 seconds

The foregoing and advantages of the present disclosure will become more apparent from the following detailed description of several of the embodiments, which proceeds with reference to the accompanying drawings.

### BRIEF DESCRIPTION OF THE DRAWINGS

FIG. 1 is a perspective view of an exemplary embodiment of an advertising apparatus looking down at the top of the apparatus.

FIG. 2 is a perspective view of the advertising apparatus shown in FIG. 1, rotated 180°.

FIG. 3 is a perspective view of the top piece of the advertising apparatus shown in FIG. 1, showing the external surface of the top piece relative to the assembled apparatus.

FIG. 4 is a perspective view of the top piece of the advertising apparatus shown in FIG. 1, showing the internal surface of the top piece relative to the assembled apparatus.

FIG. 5 is a perspective view of the bottom piece of the advertising apparatus shown in FIG. 1, showing the external face of the bottom piece relative to the assembled apparatus.

FIG. 6 is a perspective view of the bottom piece of the advertising apparatus shown in FIG. 1, showing the internal face of the bottom piece relative to the assembled apparatus.

FIG. 7 is a perspective view of a LED mounting assembly for the advertising apparatus shown in FIG. 1.

FIG. 8 is a perspective view of a cam locking mechanism of the advertising apparatus shown in FIG. 5.

FIG. 9 is a perspective view of a cam locking mechanism of the advertising apparatus shown in FIG. 5 rotated 180°.

FIG. 10 is a perspective view of a universal mounting system base plate for the advertising apparatus shown in FIG. 1, showing the external face of the universal mounting system base plate relative to the assembled apparatus.

FIG. 11 is a perspective view of a universal mounting system base plate for the advertising apparatus shown in FIG. 1, showing the internal face of the universal mounting system base plate relative to the assembled apparatus.

FIG. 12 is a perspective view of a battery compartment cover for the advertising apparatus shown in FIG. 1, showing the external face of the battery compartment cover relative to the assembled apparatus.

FIG. 13 is a perspective view of a battery compartment cover for the advertising apparatus shown in FIG. 1, showing the internal face of the battery compartment cover relative to the assembled apparatus.

FIG. 14 is a top down sectional view of the advertising apparatus shown in FIG. 1.

FIG. 15 is a bottom up sectional view of the advertising apparatus shown in FIG. 1.

FIG. 16 is a back elevation view of the advertising apparatus shown in FIG. 1.

FIG. 17 is a side sectional view of the advertising apparatus shown in FIG. 1.

FIG. 18 is a circuit diagram of an exemplary circuit for controlling the advertising apparatus shown in FIG. 1.

FIG. 19 is a flattened view of a C-shaped clamp of the advertising apparatus shown in FIG. 1.

FIG. 20 is a right-side view of the C-shaped clamp shown in FIG. 19 with a pair of digital image photographs of a mounting screw.

All illustrations of the drawings are for the purpose of describing selected embodiments of the present invention and are not intended to limit the scope of the present invention.

### DETAILED DESCRIPTION

The singular terms “a,” “an,” and “the” include plural referents unless context clearly indicates otherwise. The term “comprises” means “includes.” In case of conflict, the present specification, including explanations of any terms, will control.

The present disclosure concerns embodiments of an advertising apparatus suited for capturing the attention of a person shopping in a retail location or in another environment where it may be advantageous or necessary to deliver information to the person as he or she passes through a certain area. The advertising apparatus of the present invention achieves this goal by using a combination of two mechanisms that may deliver two separate, but useful stimuli to the person: (1) a motion sensor that detects the movement of an approaching person and, as a result, causes the display to illuminate when the person draws near, thus stimulating the person's reticular activating system by drawing the visual attention of the customer to the advertising apparatus at the appropriate time; and (2) delivering an electronic notification to the person's wireless mobile device, such as a smart phone, tablet, or other wireless device. Additionally, the advertising apparatus is optimized to conserve power usage, for example prolonging battery life. Using one or more universal mounting systems the advertising apparatus has the advantage of being mountable to a horizontal or vertical surface, for example using a clamp, magnets, or suction cups and the like. In addition, when mounted, the advertising apparatus has the further advantage of or providing a convex display surface that is viewable from multiple angles, such as from 180°. By way of example a potential customer walking either direction down a supermarket aisle may view the graphics present on the display surface of the advertising apparatus, particularly when the display surface is illuminated. A potential customer may also view the graphics as he or she approaches and passes by the advertising apparatus. Thus, one of the many advantages of the disclosed advertising apparatus is that it offers a 180° viewing angle.

The disclosed advertising apparatus uses electronic means to generate interest in the graphically displayed advertising present on the display surfaces of the advertising apparatus. This is accomplished by illuminating the advertising graphics such that an approaching potential customer sees the illuminated advertising graphic and may be drawn to it. Rather than having a sign that is constantly lit or flashes at intervals at a constant rate, which tends to be either lost in the milieu of other sights and sounds or, in the case of a constantly flashing sign, somewhat annoying, the disclosed apparatus illuminates only when a potential customer comes into close proximity, thus drawing the customer's attention to the apparatus and its accompanying graphics. In essence the light appears out of nowhere when the potential customer is not expecting it and has the effect of grabbing a person's attention, which in psychological terms is called the reticular activating system, e.g. when a person sees something happening in his or her environment and proceeds to investigate. Activation of the reticular activating system often results in increased blood flow and neuron activity, and heightened attention, all of which are useful when attempting to stimulate and attract a consumer's attention through in-store advertising. However, rather than being activated solely by the customer's proximity, the advertising apparatus disclosed herein includes sophisticated circuitry designed both operate in a powered-on state for attracting a consumer's attention and a powered-off state for rest and power conservation, thereby providing the additional benefit of prolonging battery life of the stand-alone apparatus.

The advertising apparatus offers the advantage of delivering an electronic notification to the customer's wireless mobile device. Using a low energy wireless transmitter, often referred to as a “proximity beacon,” to deliver small packets of data, or “push notifications,” to the customer's wireless mobile device. If the customer's wireless mobile device allows the reception of such electronic notifications, the mobile device may vibrate, ring, or display an alert message on its screen. In this way, the advertising apparatus is doubly effective—the display surface delivers a visual stimulus to the consumer that activates the reticular activating system and draws the consumer's attention toward the display surface at or about the same time that the advertising apparatus' proximity beacon delivers an electronic notification to the customer's mobile device. Thus, the advertising apparatus delivers a “push” notification to the consumer's wireless device at the same time that the advertising apparatus “pulls” the consumer's attention towards the illuminated display. Furthermore, it is likely that if the consumer ignores or fails to recognize the push notification delivered to the mobile device, the consumer's attention may be attracted by the illuminated advertising apparatus, and it is possible that the consumer may view the notification at some later time, perhaps before checkout or even at home. In this way, the electronic notification may remind the consumer of the items, services, or brands seen previously on the advertising apparatus, which may lead to future sales or internet purchases.

Another advantage of the advertising apparatus is that its design is optimized such that no tools are required for installation, which means that it is easy for employees to install and service a battery door in the back of the display. Furthermore, the location of the battery door and power switch discourages theft of batteries and tampering.

One of the many advantages of the disclosed advertising apparatus is that it has the ability to be re-used on a continual basis, e.g. it is not viewed as a single use, single product advertising apparatus. Because both the graphics, and the power supply, in the case of batteries, have the ability to be changed out, the disclosed advertising device has an environmental advantage compared to other conventional point of sale static and lighted signs in the market place. This ability to alter the advertising apparatus's display graphics further provides an advantage to the retailer in lowering costs. Additionally, if necessary, the wireless transmitter may be easily exchanged to quickly upgrade the advertising apparatus to include a wireless transmitter that has a new battery or power supply, a greater transmission radius, an updated version of the electronic notification delivered to the consumer's wireless device, compatibility with new and emerging state-of-the art wireless technologies, or for any other reason. The ease with which the display graphics and the wireless transmitter may be upgraded or changed also allows for the advertising apparatus to be rapidly re-deployed to promote different products in a different area of the store.

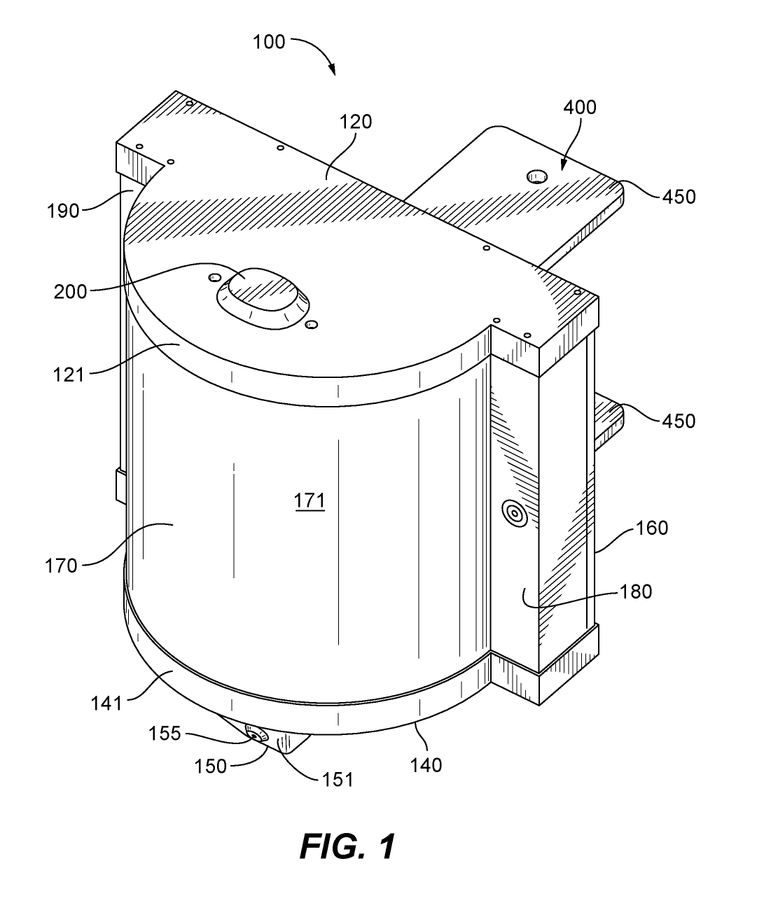

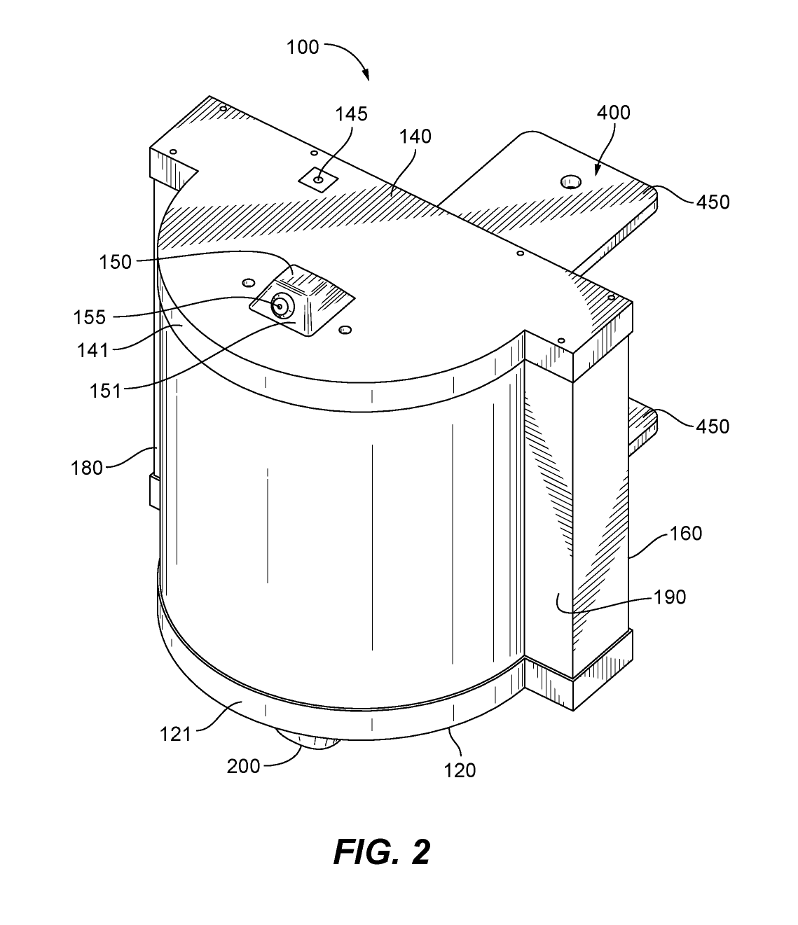

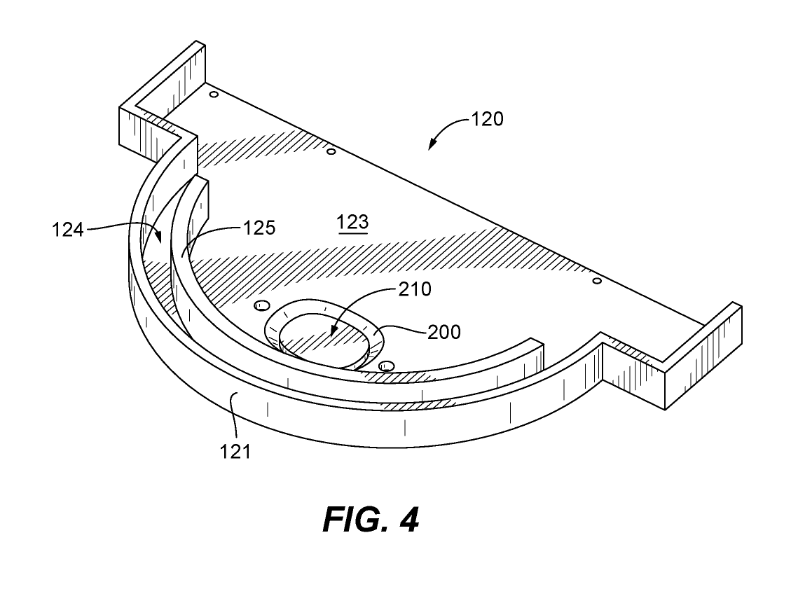

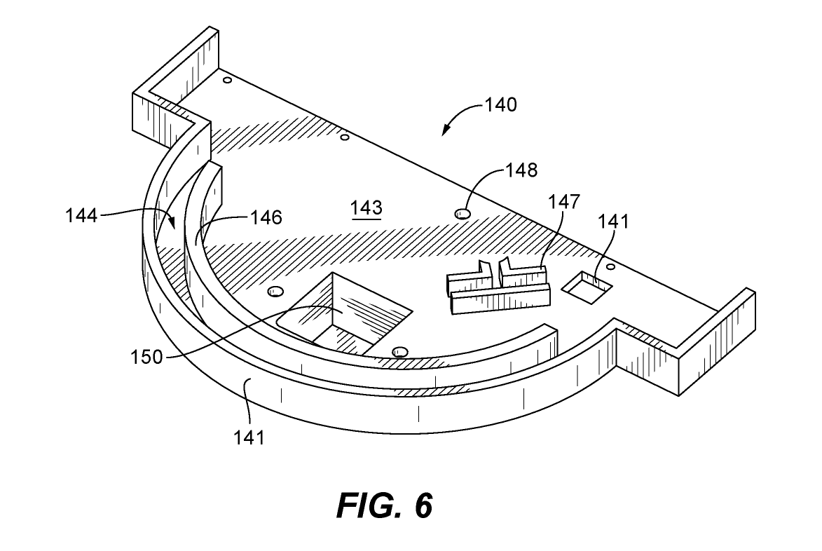

FIG. 1 shows an exemplary advertising apparatus 100 according to one embodiment of the present invention. With reference to FIG. 1, advertising apparatus 100 includes top piece 120, which defines a front edge 121, bottom piece 140, which defines a front edge 141, a motion sensor housing 150 for a motion sensor 155, and optionally a charging and/or adaptor plug 145 (as shown on FIG. 2)), a back piece 160, and front display piece 170, and optionally a right brace 180 and a left brace 190. In this view, bottom piece 140 is partially occluded from view. Universal mounting system 400, which is also partially occluded from view, is shown attached to back piece 160 with clamp mount 450 protruding therefrom. Also shown in this view is wireless transmitter housing 200, which in one embodiment protrudes upwardly from top piece 120. Motion sensor housing 150 and wireless transmitter housing 200 may be located anywhere on advertising apparatus 100, including in some embodiments inside the advertising apparatus 100. In this view, individual pieces of advertising apparatus 100, such as top piece 120, bottom piece 140, and back piece 160 are shown assembled together using small screws; however, it is contemplated that the individual pieces may be assembled using alternative approaches, such as rivets, fasteners, snap construction, or even adhesives. Front display piece 170 is the principal place for graphics to be placed, and is configured to be surface illuminated by various lighting sources, such as light emitting diodes (LEDs) or an electroluminescence (EL) light source and the like, such that front display piece 170 gives off light, glows, or appears illuminated. This, in turn, illuminates a graphic or multiple graphics, such as a graphic depicting a particular product or service. For example, an advertisement for a product or service placed on the front surface 171 of front display piece 170 is illuminated for a potential customer. It is contemplated that the graphics would be interchangeable, for example as thin sheets of printed plastic (not shown) and the like that are interchangeably inserted in front of front surface 171 of front display piece 170. Alternatively, front display piece 170 may be made from transparent material behind which a separate printed graphic may be interchangeably inserted for illumination by a light source. In either case, the advertising graphics may be easily replaced by sliding precut sheets of material into channel 124 (FIG. 4) defined by top piece 120 and channel 144 (FIG. 6) defined by bottom piece 140, which together secure the graphics into place. Front display piece 170 has a generally convex curvature to promote 180° visibility for any information displayed thereon. While reference is given to the top and bottom of the advertising apparatus, it is contemplated that the advertising apparatus can be installed upside down and still function correctly, for example as installed on a low shelf, such that motion sensor housing 150 and motion sensor 155 are on the top of the apparatus relative to the earth. In such a case, the graphics orientation can be rotated to retain the correct visual orientation.

The top piece 120, back piece 160, bottom piece 140 and front edge 141 may be made of any material; however, plastic, such as thermo-moldable plastic, is preferred. The front display piece 170 is typically made of a substantially clear material, such that when the material is edge lit, light passes through the material. In some embodiments, the front display piece is a light guide, which is a material that when edge lit guides light across the material to illuminate the material in a uniform manner or substantially uniform manner. In some embodiments, this is done using a piece of plastic that has been printed so that it has spots on it that disperse the light to the face of the material. Alternatively, such edge-lens technology often uses small bumps and/or indentations that guide the light to the surface of the material and illuminate the display surfaces. Essentially, this technology pulls the light across the plane evenly. For example, for a square piece of acrylic that is illuminated along one edge, printing and/or etching on the internal surface of the material pulls the light evenly across the entire area of the material effectively back lighting the piece. In some embodiments, the light or illumination source may be electroluminescence (EL). EL is an optical and electrical phenomenon in which a material emits light in response to the presence of an electric current or to a strong electric field. Examples of the range of EL materials include thin-film zinc sulfide doped with manganese and semiconductors containing Group III and Group V elements, such as indium phosphide (InP), gallium arsenide (GaAs), and gallium nitride (GaN). Typically the EL material is a thin film, which can be mechanically coupled to a backer, such as a plastic backer, for example the front display piece of the disclosed advertising apparatus. Electroluminescent technologies have low power consumption and are thus well suited to use in the disclosed advertising apparatus.

With further reference to FIG. 1, motion sensor housing 150 is shown protruding from bottom piece 140 with motion sensor 155 mounted thereon. As mentioned previously, motion sensor housing 150 can be positioned anywhere on the outer surface of bottom piece 140 or other parts of the advertising apparatus. As is shown in FIG. 1, in certain embodiments, motion sensor housing 150 is positioned slightly recessed from the front edge 141 of bottom piece 140. This provides several advantages, one of which is to decrease the probability that a potential customer's interaction with the apparatus (such as bumping the apparatus) will damage the lens portion of motion sensor 155. Another advantage of positioning motion sensor housing 150 in this manner is that it limits the effective range of motion sensor 155, allowing for tuning the apparatus to capture the movement of a potential customer at an optimal range for viewing the apparatus when it is triggered. For example, positioning motion sensor housing 150 recessed from the edge limits the range of motion sensor 155 from the furthest extent, for example 30 feet or greater, to about 10 feet, thus the range of the device can be tuned. In addition, the front facet 151 of motion sensor housing 150 may be angled, such that mounted motion sensor 155 can be directed to the most likely place a customer will travel. This allows for mounting the assembled advertising apparatus at either a relatively low or high position, for example placed on a lower shelf or a higher shelf. This can be accomplished by placing the sensor housing on a single side (top or bottom) and reversing the orientation of the apparatus, for example by using a reversible bracket in conjunction with universal mounting system 400. In this arrangement, tilting the front facet 151 of sensor housing 150 angles the mounted motion sensor up or down.

Typically motion sensor 155 is an infrared sensor, such as a passive infrared sensor, although other motion sensors are contemplated for use in the apparatus. In preferred embodiments, the motion sensor is an infrared sensor, such as a multifaceted infrared sensor. Passive infrared sensors allow sensing of motion by detecting changes in levels of infrared radiation. In some examples, the sensor in a motion detector splits in one or more facets, which can be used to detect a change in motion. In certain embodiments, a multifaceted lens detects the presence of an approaching customer, such as by detecting the body heat of such customer, and as the customer's heat moves across two, three or even four facets of the lens, it triggers the apparatus. This has the advantage of limiting the interaction to actual potential customers and it also limits the triggering to when the potential customer is actually within range and capable of seeing the display and its illuminated graphics. For example, if a customer were to walk part way into the sensor's field of view and then reverse course, the sensor would not activate and would conserve battery power, rather than activating for a customer who is now facing the opposite direction.

FIG. 2 shows an embodiment of advertising apparatus 100 as depicted in FIG. 1 rotated about the horizontal such that top piece 120 is partially occluded from view and facing downward, while bottom piece 140 is entirely visible and facing upward. Optional charging and/or AC/DC adaptor plug 145 is visible on bottom piece 140.

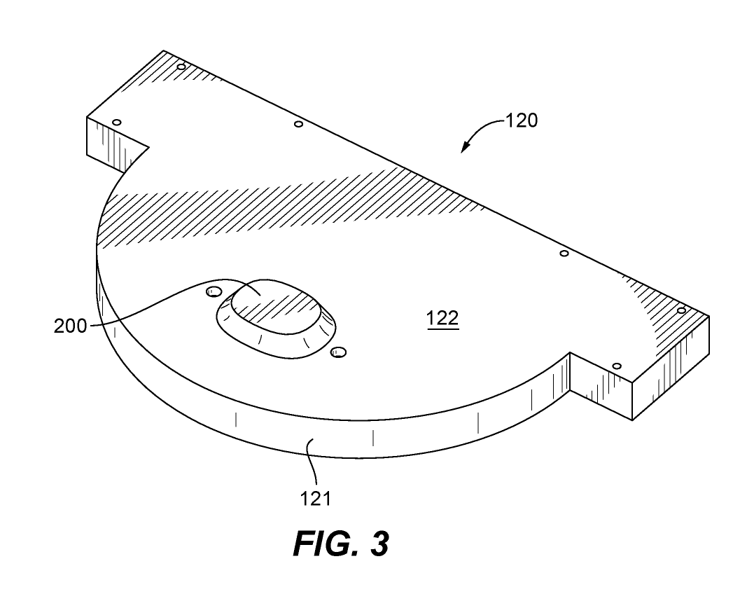

FIG. 3 and FIG. 4 best show top piece 120 of a preferred embodiment of the advertising apparatus. FIG. 3 shows the front edge 121 and exterior surface 122 of top piece 120 that help to bound the front sides of the assembled apparatus. The exterior of wireless transmitter housing 200 is shown defined on exterior surface 122 of top piece 120.

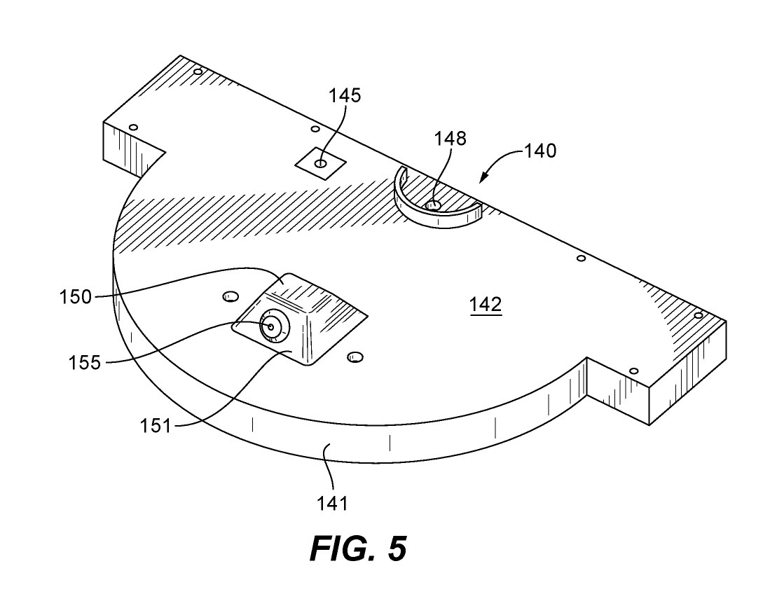

FIG. 4 shows top piece 120 rotated 180° relative to FIG. 3. The depiction shows internal features of the top piece of one preferred embodiment of the advertising apparatus, including front edge 121 and interior surface 123. A channel 124 formed by front edge 121 and channel wall 125 is provided into which front display piece 170 (see e.g., FIGS. 1 and 2) may be inserted. Additionally, the final assembled advertising apparatus may include a lighting system to provide edge lighting such as an LED light system, which may be inserted into channel 124. Alternatively, the lighting system can be inserted into channel 144 of the bottom piece 140 (shown in FIGS. 5 and 6). In some embodiments, top piece 120 may also be equipped with reinforced ribbing or support bracing (not shown) to improve the structural integrity of the advertising apparatus when fully assembled.

FIG. 4 also shows an interior view of wireless transmitter housing 200 with a wireless transmitter 210 disposed therein. In the embodiment shown, wireless transmitter housing 200 is shown centrally located on top piece 120 proximate to top piece front edge 121; however, it should be apparent that wireless transmitter housing 200 may be positioned anywhere on top piece 120 or, alternatively, on the outer surface of bottom piece 140 (FIGS. 1 and 2). Wireless transmitter housing 200 provides a protective and tamper-proof enclosure for a wireless transmitter 210, which may be any form of short-range radio transmitter, commonly referred to by those in the art as a “proximity beacon.” Wireless transmitter 210 may be affixed to the interior of wireless transmitter housing 200 by adhesive, retaining clips, or other appropriate means. It should also be recognized that in alternative embodiments wireless transmitter 210 may be affixed directly to the exterior or interior surfaces 122 (FIG. 3), 123 of top piece 120 or another surface of the advertising apparatus. The position of the wireless transmitter 210 and the incorporation of a wireless transmitter housing 200 can be functions of the transmission requirements of the transmitter, aesthetic preferences, and concerns over security or protection of the wireless transmitter.

As mentioned previously, in a preferred embodiment, wireless transmitter 210 may be any variety of commonly known proximity beacons manufactured by third parties such as Qualcomm, Gimbal, and other manufacturers of wireless devices. Proximity beacons are small, self-contained wireless devices that transmit low power radio frequencies to other wireless-enabled devices, such as smart phones, tablets, laptop computers and the like, that come within a relatively close range of the proximity beacon. The proximity beacon broadcasts a packet of code that is received by the wireless-enabled device. The wireless-enabled device may then provide its user with an alert notification, such as a ring tone or vibration, a screen message or image, or other form of notification. In some embodiments, the proximity beacon will transmit code that contains information such as the proximity beacon's name, an icon, and/or other information which may then be interpreted by the wireless device as a coupon deal in certain retail environments, information about products being promoted by the advertising apparatus, or even offering the consumer a customized greeting. Additionally, in some embodiments, the proximity beacon can provide information to an administrator assigned to monitor the performance and operation of the advertising apparatus, such as the number of wireless mobile devices that have passed the advertising apparatus in a defined period of time, the rate at which consumers respond to or ignore the notifications on their wireless devices, and other similar data that may be analyzed to optimize the marketing and advertising value of the advertising apparatus.

Proximity beacons typically include an internal, low voltage battery power source. For this reason, proximity beacons are configured to transmit at a rate and at a distance that optimizes reactiveness on nearby wireless-enabled devices while also maximizing the proximity beacon's battery life.

The incorporation of the benefits of both the motion sensor 155 and a the wireless transmitter 210 in the preferred embodiment allows the illumination of the advertising apparatus and its display graphics at the same or nearly the same time that an alert appears on the nearby customers' wireless device. As a result, the preferred embodiment of the advertising apparatus increases the likelihood that the consumer's attention will be attracted to the product promoted by the advertising apparatus because the consumer receives both a visual stimulus in the form of the illuminated graphics on the advertising apparatus and an electronic notification on his or her wireless device.

FIG. 5 and FIG. 6 best show bottom piece 140 of a preferred embodiment of the apparatus. FIG. 5 shows the front edge 141 and an external surface 142 of bottom piece 140 that help to bound the front sides in the assembled apparatus. The exterior of motion sensor housing 150 and motion sensor 155 housed therein are shown defined on exterior surface 142 of top piece 140.

FIG. 6 shows bottom piece 140 rotated 180° relative to FIG. 5. The depiction shows internal features of the bottom piece of one preferred embodiment of the advertising apparatus, including front edge 141 and interior surface 143. A channel 144 formed by front edge 141 and channel wall 146 is provided into which front display piece 170 fits (see e.g., FIGS. 1 and 2). In the assembled apparatus, channel 144 works together with channel 124 defined on top piece 120 (FIG. 4) to hold printed replaceable graphics in front of the front surface 171 of front display piece 170 (FIG. 1). In this way, front piece 170 and the printed graphics (not shown) are held securely in place, for example by friction. Alternatively, if graphics are printed directly onto display piece, display piece may be interchanged by sliding it out of channel 144. In addition in the final assembled advertising apparatus, a lighting system to provide edge lighting, such as an LED light system, can be nested into channel 144. Alternatively, the lighting system can be nested into the channel 124 of the bottom piece (shown in FIGS. 3 and 4). In some embodiments, bottom piece 140 may also be equipped with reinforced ribbing or support bracing (not shown) to improve the structural integrity of the advertising apparatus when fully assembled. Also shown is the charging and/or AC/DC adaptor plug mounting hole 141 with charging and/or AC/DC adaptor plug removed, a cam locking mechanism mounting hole 148 and an optional wire guide 147, and motion sensor housing 150. The location of charging and/or AC/DC charging and/or AC/DC adaptor plug mounting hole 141 can be placed as desired, including the top piece or back piece.

In one preferred embodiment, when the advertising apparatus is fully assembled, bottom piece front edge 141 and top piece front edge 121 (FIGS. 3 and 4) are curved in a convex manner to promote 180° viewing of the front display piece 170 (FIGS. 1 and 2) and the graphics supported thereby (not shown) when inserted into channel 144 and channel 124 (FIG. 4). In the assembled apparatus, the replaceable graphics slide into channel 144 and 124, and are held in place, for example by friction.

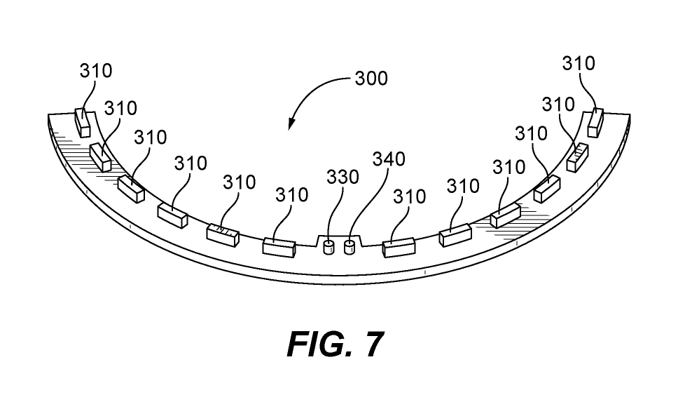

FIG. 7 shows one embodiment of a lighting source to illuminate the apparatus in the form of an LED assembly that can be inserted into top piece channel 124 (FIG. 4) and/or bottom piece channel 144 (FIG. 6). Alternatively, the lighting source could be slotted into grooves provided in the back piece 160 or left or right braces 180, 190 (FIG. 1). With reference to FIG. 7, one embodiment of an LED assembly 300 includes a printed circuit board circuitry with integral LEDs 310 and positive and negative terminals 330 and 340, respectively. In this embodiment, 12 LEDs are shown; however, it is contemplated that more or fewer could be used, for, example any range of LEDs necessary to give off the desired illumination, including anywhere from 1 to 16 or more LEDs, depending on the application. In the embodiment shown in FIG. 7, 12 LEDs are shown to achieve desired lighting and power consumption.

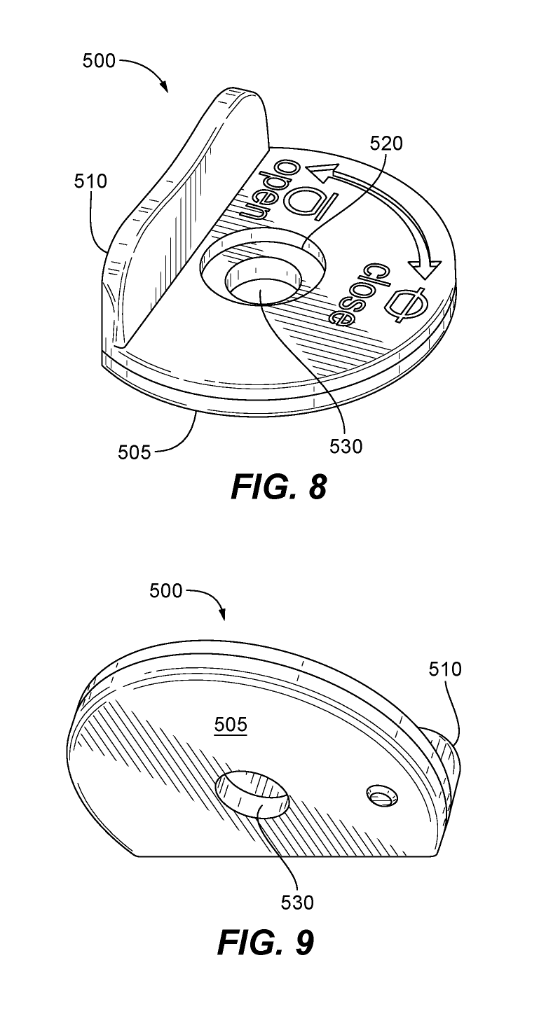

FIGS. 8 and 9 show a universal mounting system cam locking mechanism. In the open position, the universal mounting system is free to slide up and down slots provided in the back piece of the apparatus. With reference to FIG. 8, cam locking mechanism 500 includes flat portion 505 that in one embodiment sits against the bottom piece of the apparatus. Cam locking mechanism 500 also includes a raised portion 510 for turning cam locking mechanism 500, hole 530 for a fastener attaching the cam locking mechanism 500 to hole 148 (FIG. 5) defined in the bottom piece of the apparatus, and counterbore 520 so that a fastener can be seated substantially flush with the top surface of cam locking mechanism 500.

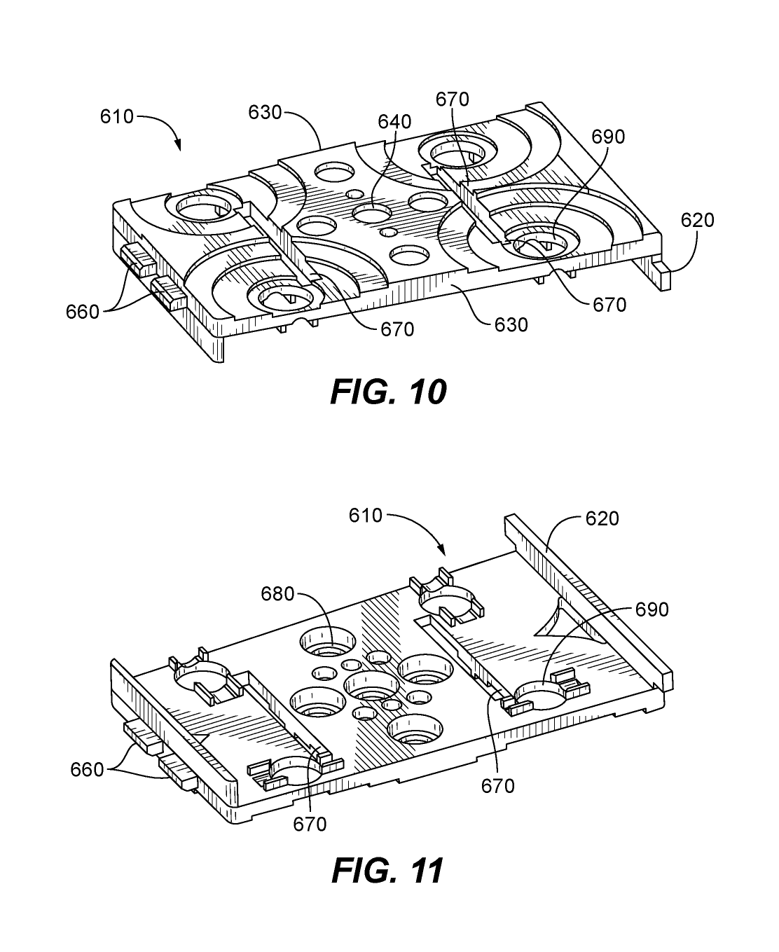

A preferred embodiment of the universal mounting system base plate is best shown in FIGS. 10 and 11. With reference to FIG. 10, which shows the outer face of universal mounting system base plate 610 relative to the assembled apparatus, universal mounting system base plate 610 includes seeding tabs 620, sides 630, mounting holes 640, guide tabs 660, clamp mounting slots 670 and suction cup mounting holes 690. Universal mounting system base plate 610 includes several features to mount additional optional mounting hardware. Mounting holes 640 can be used to mount additional hardware using fasteners for placement of the assembled apparatus, including a clamp, for example clamp mount 450 shown in FIG. 1. Clamp mount 450 shown in FIG. 1 can be guided though clamp mounting slots 670 and attached with fasteners to universal mounting system base plate 610 using fasteners to mounting holes 640. In addition, suction cups can be mounted to suction cup mounting holes 690. Guide tabs 660 and seeding tabs 620 position universal mounting system base plate 610 within the channel on the back piece of the advertising apparatus.

The universal mounting system addresses several challenges present in an advertising environment. First is mounting. Given the diversity in mounting situations, such as different size shelving, a universal mounting system was developed that provides the ability to customize the apparatus to a variety of situations likely to be encountered. As a solution, the inventor devised a universal mounting system that includes a universal mounting system base plate that slips into a slot on the back of the advertising apparatus and locks in place, using the universal mounting system cam locking mechanism. The universal mounting system is configured to accommodate a variety of mounting hardware. In one embodiment, the universal mounting system includes a clamp that can be finger tightened for placement on a horizontal shelf and attaches to the universal mounting system base plate. In another embodiment, the universal mounting system includes a magnetic attachment that attaches to the universal mounting system base plate. In another embodiment, the universal mounting system includes one or more suction cups that attaches to the universal mounting system base plate. In addition, to combat tampering with the apparatus and battery theft, when the universal mounting system base plate is in place, such as locked in place with the cam locking mechanism, both the on/off switch and the battery compartment are occluded from view and hence deter tampering. This deters persons from either tampering with the apparatus or stealing batteries from the apparatus in a surveillance environment, such as a store. The clamp mounting hardware is typically a C-shaped steel bracket. For suction cup mounting, any appropriate number of suction cups, including between about 1 and about 16 suction cups, may be used depending on the application.

In some embodiments, the sides of the universal mounting base plate are substantially non-parallel, such that the universal mounting base plate fits securely in a channel of the back piece of the advertising apparatus. One advantage of using substantially non-parallel sides of the universal mounting system base plate is that it allows the universal mounting system base plate to slide it up and down and lock in place with a simple cam lock, with all of the weight supported at the top and on the sides, such that there is no one area of the universal mounting system base plate that is bearing an unreasonable amount of weight.

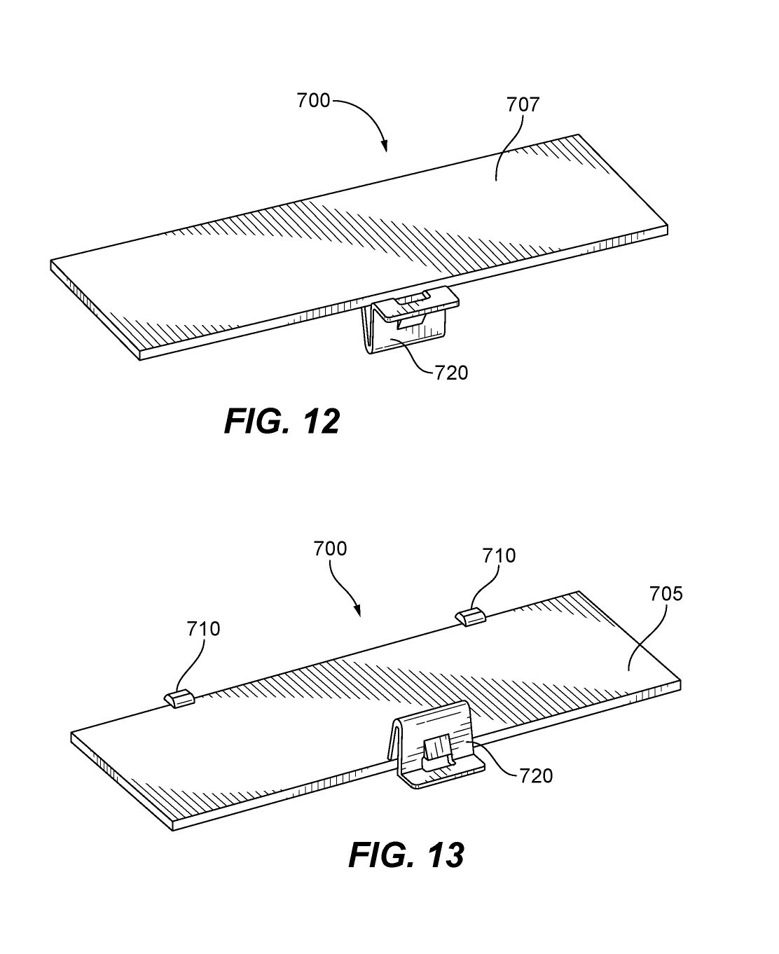

FIGS. 12 and 13 show a battery compartment cover for use in one embodiment of the advertising apparatus. With reference to FIGS. 12 and 13, battery compartment cover 700 includes inner surface 705, outer surface 707, location tabs 710 and snap lock 720. Location tabs 710 slide into recesses provided on the back piece 160 (FIG. 1) to locate battery cover 700 with respect to the back piece. Snap lock 720 snaps into place in a recess in the back piece and can be actuated by hand.

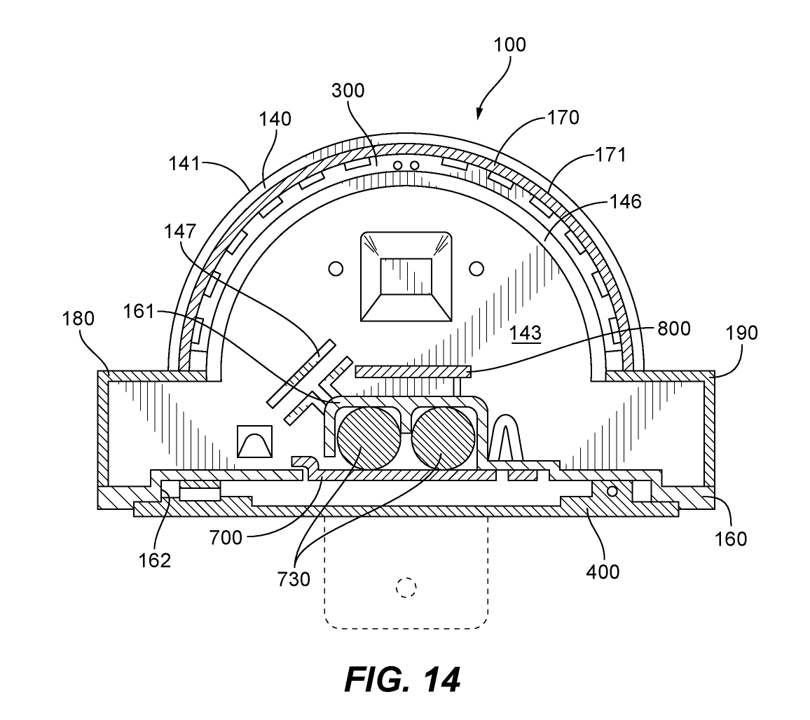

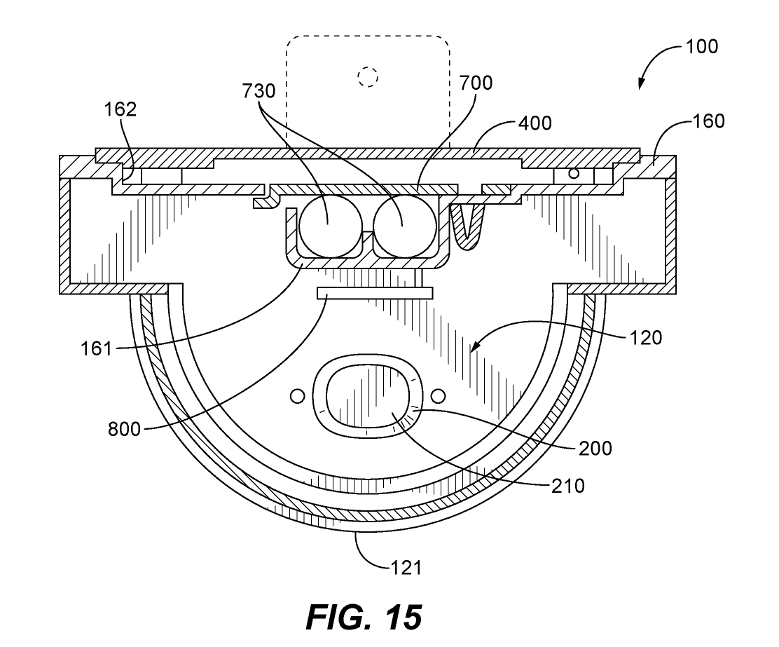

The internal structure of the assembled apparatus is best shown in FIGS. 14 and 15. With reference to FIG. 14, a top down sectional view, advertising apparatus 100 includes back piece 160, which defines a battery compartment wall 161 and a mounting channel 162, wire guide 147, charging/AC adaptor opening 145, front display piece 170, right brace 180, and left brace 190. Also shown is universal mounting system 400 inserted into back piece channel 162, battery compartment cover 700, batteries 730 and circuit board 800. Battery compartment wall 161 is integral to back piece 160 and, together with battery compartment cover 700, forms a compartment to secure batteries 800 in place. In this view, front surface 171 of front display piece 170 is shown and is where printed graphics may be positioned. Circuit board 800, which controls the electronic aspects of advertising apparatus 100, including the lighting source depicted as LED Assembly 300, is shown attached to battery compartment wall 161 for convenience. It is contemplated that circuit board 800 may be attached to any convenient surface within the assembled advertising apparatus.

With reference to FIG. 15, a bottom up sectional view, advertising apparatus 100 includes battery compartment wall 161, universal mounting system base plate 400 inserted into back piece channel 162, batteries 730 and circuit board 800. As described in connection with FIG. 15, battery compartment wall 161 is shown as integral to back piece 160 and, together with battery compartment cover 700, forms a compartment to secure batteries 730 in place. In this view, front surface 171 of front display piece 170 is shown and is where printed graphics may be positioned. Also shown is wireless transmitter housing 200, which is defined by top piece 120, with a wireless transmitter 210 disposed therein. In the embodiment shown, wireless transmitter housing 200 is shown generally centrally located on top piece 120 proximate to top piece front edge 121; however, it should be apparent that wireless transmitter housing 200 may be positioned anywhere on top piece 120 or, alternatively, elsewhere on the advertising apparatus. In the embodiment shown, wireless transmitter 210 is affixed to the interior of wireless transmitter housing 200 by adhesive; however, retaining clips or other appropriate means for securely fastening wireless transmitter 210 in place may be used in other embodiments.

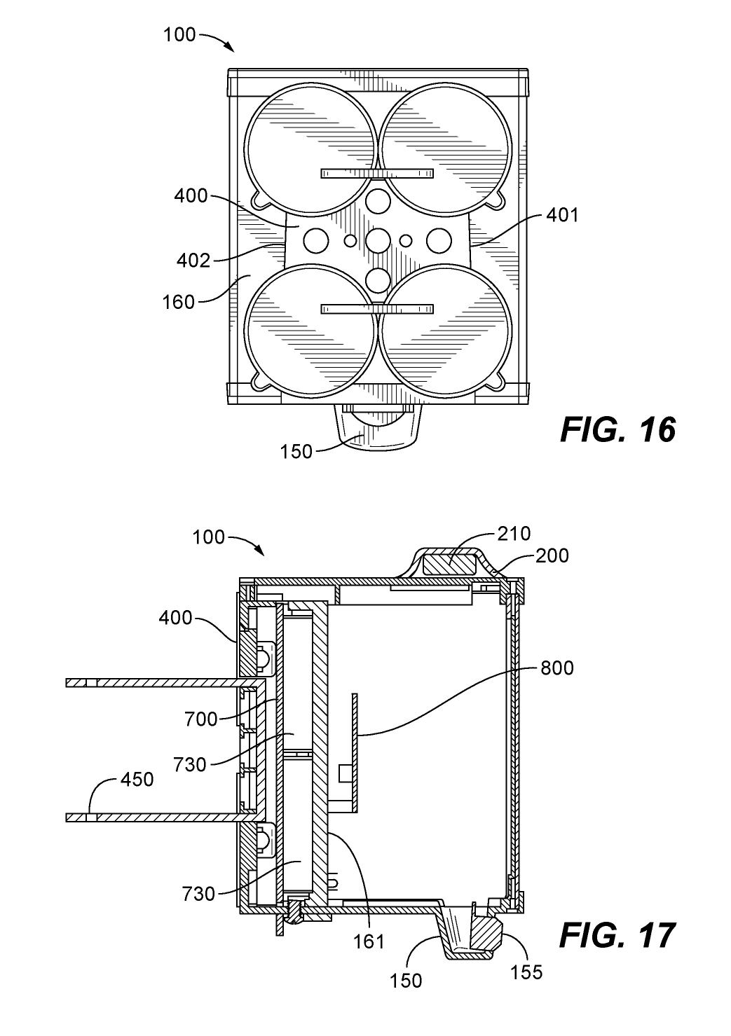

FIG. 16 is a rear view of the advertising apparatus 100, showing back piece 160, with universal mounting system base plate 400 installed. Also shown is a superposition of the clamp bracket and the suction cups as mounted in universal mounting system base plate 400. This view also shows base plate 400 having the substantially non-parallel vertical sides 401, 402, received into channel 162 (FIGS. 14 and 15) defined in back piece 160.

FIG. 17 is a side view cut away of assembled advertising apparatus 100. In this view, battery compartment wall 161 is visible as is motion sensor housing 150, with motion sensor 155 installed. Also visible is wireless transmitter housing 200, with wireless transmitter 210 installed. Also shown are universal mounting plate 400, with mounting clamp guide 450 installed, battery compartment cover 700, batteries 730, and circuit board 800.

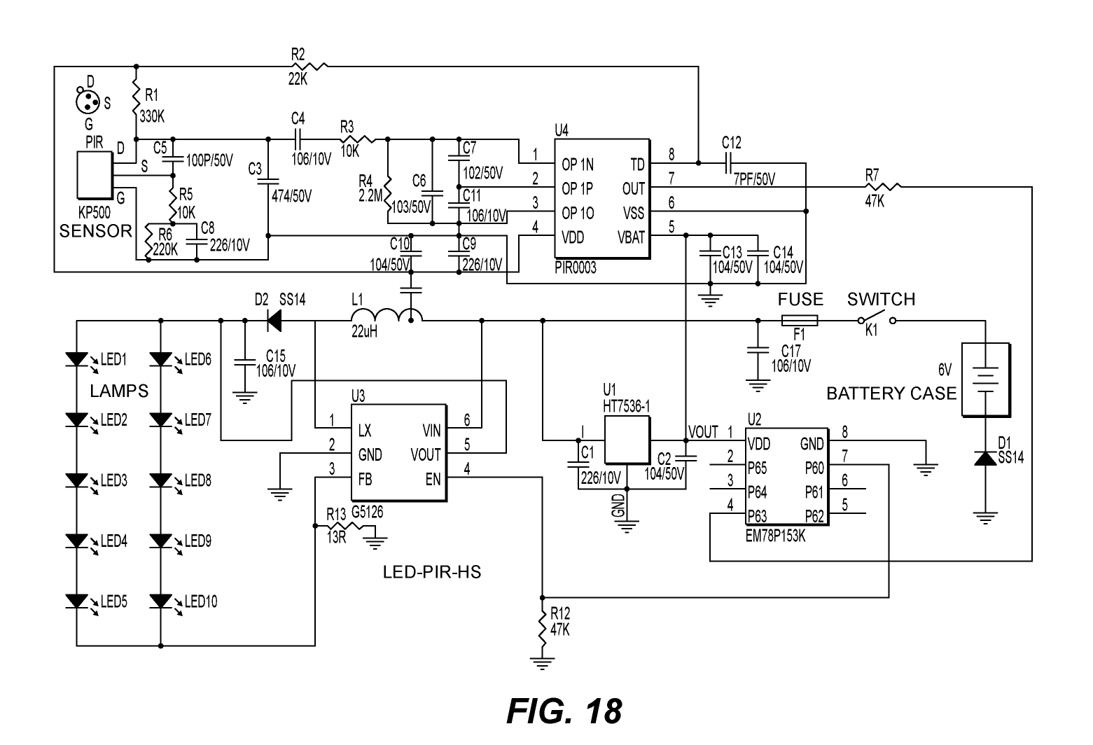

FIG. 18 is an exemplary circuit for controlling the electronics of the advertising apparatus. The circuit is designed to operate the advertising apparatus for about 30 days, for example using pulse modulation. Specific technologies known to those of ordinary skill in the art including those disclosed herein are applied which are then used to bring the current drain down to an acceptable level so that the apparatus can function in a location, such as in a store, for the 30-day programs without battery changes. In some embodiments, the circuit includes LEDs and an LED controller. The LED controller can be configured to further reduce the current drain and to control the light. In some embodiments, the LEDs are controlled such that they do not light at the full battery power available to them. For example, they light at a fraction of the full power available for a short duration of time, for example as a pulse, which provides a rest period for the batteries, so that in turn extends battery life considerably. In some embodiments, the circuit includes EL material and optionally a controller for the EL material. The controller for the EL material can be configured to further reduce the current drain and to control the light. In some embodiments, the EL material is controlled such that they do not light at the full battery power available to them. For example, they light at a fraction of the full power available for a short duration of time, for example as a pulse, which provides a rest period for the batteries, so that in turn extends battery life considerably.

The circuit also includes a passive infrared sensor. The passive infrared sensor allows the advertising device to be interactive with the potential customer and to remain static when the potential customer is not in close range of the advertising apparatus. This arrangement limits battery drain and at the same time assures the longevity of the product in the intended application. As a potential customer approaches, the passive infrared sensor will trigger so that the advertising apparatus is within the potential customer's peripheral vision at that point. In this way, the passive infrared sensor limits the illumination of the apparatus to only those times when a consumer walks by the apparatus, rather than just flashing indiscriminately (such as an LED flashing on the end of an aisle). In some embodiments, the circuit includes one or more LED strips, which may include as many as 32 LEDs each. In one embodiment, there are two LED strips of 12 LEDs apiece coupled to an LED driver, coupled to a passive infrared circuit, which then controls the on/off function, coupled to a power source, such as a DC or AC power source, for example batteries. In some embodiments, there is also a DC or AC input charging port, for example, for running the advertising device on DC input, rather than batteries, which if available would be a cost savings. In some examples, when the DC or AC input charging port is plugged, the internal power supply from the batteries is superseded. In other embodiments, rechargeable batteries are used (for example, Nickel-Cadmium (Ni-Cad), Lithium Ion (Li-ion) and Nickel-Metal-Hydride (Ni-MH)) and plugging in a charger or AC adapter recharges the batteries.

One advantage of the advertising apparatus of the present invention is the efficient use of limited battery power. In some embodiments, the circuit is configured to operate as on and forced off circuit, which helps optimize battery life. This means that the advertising device is active for a period of time and then inactive for a period of time before becoming active again in a cyclic fashion. The forced rest is designed for two things: (1) to reduce the amount of battery power required for normal operation; and (2) to reduce the possibility of someone triggering the advertising apparatus for amusement, for example, a child who waves their hands in front of it, which could also dramatically reduce the battery life. In some embodiments, the circuit is configured for a powered-on period of about 1 second to about 120 seconds or longer. In some embodiments, a rest or powered-off period may occur between the powered-on periods and having a duration of anywhere from 1 second to about 2 minutes or longer. In one particular example, the circuit is configured to have about 7 seconds of powered-on and 20 seconds of powered-off time (also called “7/20 rule”), as this was determined to be optimal for battery life and also to improve the attraction mode or the attractor mode, particularly during periods of high traffic when multiple shoppers may pass the motion sensor's field of view in quick succession. In such a situation, an advertising apparatus that does not follow the 7/20 rule might repeatedly illuminate or remain illuminated continuously, which could quickly drain the batteries and potentially annoy shoppers. Thus, one preferred embodiment of the advertising apparatus employs the 7/20 rule to optimize battery life and reduce the likelihood of annoying shoppers with constant and/or repeated illumination cycles.

In some embodiments, the LED controller is configured such that during the powered-on time after triggering, the LED is continuously lit, alternating LED strips are lit (flashing one and then the other), or the LED strips flash simultaneously. In other embodiments, the LEDs are lit sequentially such that it appears that the illuminated surfaces of the advertising apparatus light from one side across the illuminated surface. In some embodiments, the LEDs operate sequentially, or even non-sequentially to create a ripple effect or strobe effect. In some embodiments, an EL controller is configured such that during the powered-on time after triggering, the EL is continuously lit, alternating EL pieces are lit (flashing one and then the other), or the EL pieces flash simultaneously. In some embodiments, the EL strips are lit sequentially such that it appears that the illuminated surfaces of the advertising apparatus light from one side across the illuminated surface. In some embodiments, the EL material would operate sequentially, or even non-sequentially to create a ripple effect or strobe effect.

In some embodiments, the LED controller is configured such that the LEDs are not turned on in a burst, but rather fade on, for example to a fraction of total battery power before turning off, such as with pulse modulation. In some embodiments, the LEDs fade up to about 10% to about 90% of battery power. In other embodiments, the EL controller is configured such that the EL materials are not turned on in a burst, but rather fade on, for example to a fraction of total battery power before turning off, such as with pulse modulation. In some embodiments, the EL material fades up to about 10% to about 90% of battery power.

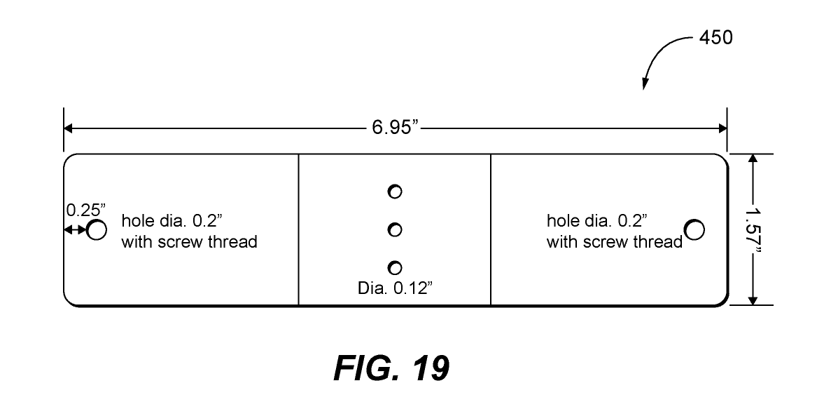

FIG. 19 is a flattened view of clamp mount 450.

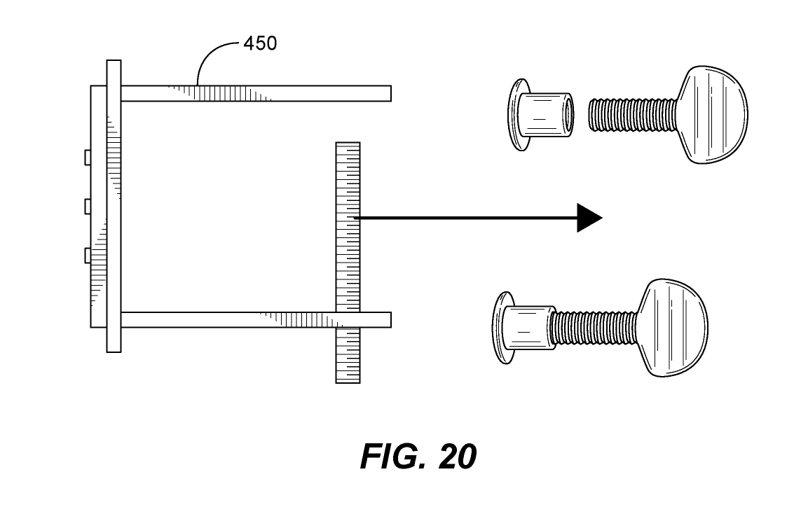

FIG. 20 is a right-side view of the clamp mount 450 with a pair of digital image photographs of a mounting screw. A non-slip coating on the mounting clamp helps keep the display in the desired position. A “foot” on the mounting screw eliminates damage to a shelf caused by a mounting screw without the foot.

In view of the many possible embodiments to which the principles of my invention may be applied, it should be recognized that illustrated embodiments are only examples of the invention and should not be considered a limitation on the scope of the invention. Rather, the scope of the invention is defined by the following claims. I therefore claim as my invention all that comes within the scope and spirit of these claims.

I claim:

1. An advertising apparatus capable of motion sensitive illumination and 180° viewing, the advertising apparatus comprising:
a top piece;
a bottom piece;
a back piece adapted for mounting the advertising apparatus to an external structure;
a front display piece adapted for displaying graphics,
wherein the front display piece has a convex shape, and
wherein the top piece, the bottom piece, the back piece, and the front display piece are mechanically coupled together;
an illumination source for illuminating the front display piece,
wherein the front display piece is illuminated when the illumination source is active;
a multifaceted motion sensor for detecting motion of a person,
wherein the multifaceted motion sensor is configured to trigger the illumination source when said person's heat moves across at least two facets of the multifaceted motion sensor;
a wireless transmitter,
wherein the wireless transmitter has a transmission radius,
wherein the wireless transmitter is capable of detecting a person carrying a wireless-enabled device when said person passes within the transmission radius of the wireless transmitter, and
wherein the wireless transmitter delivers advertising and marketing content to said wireless-enabled device; and
a power source,
wherein the illumination source and the motion sensor are coupled to the power source.

2. The advertising apparatus of claim 1, wherein the back piece has suction cups attached thereto for mounting to an external surface.

3. The advertising apparatus of claim 1, wherein the back piece has a clamp attached to the back piece for mounting to an external structure.

4. The advertising apparatus of claim 1, wherein the bottom piece defines a leading edge, wherein the leading edge retains the front display piece in place.

5. The advertising apparatus of claim 1, wherein the illumination source is attached to the bottom piece and positioned proximate to the front display piece such that the illumination source edge illuminates the front display piece.

6. The advertising apparatus of claim 1, wherein the bottom piece defines a motion sensor housing wherein the multifaceted motion sensor is mechanically coupled to the motion detector housing.

7. The advertising apparatus of claim 1, wherein the multifaceted motion sensor is a passive infrared motion sensor.

8. The advertising apparatus of claim 1, further comprising a power switch coupled to the power source to power the advertising apparatus up or down.

9. The advertising apparatus of claim 1, wherein the power source is at least one battery.

10. The advertising apparatus of claim 9 further comprising a removable cover,
wherein the back piece and removable cover together define an internal battery compartment which receives the at least one battery, and
wherein the back piece and removable cover conceal the battery compartment.

11. The advertising apparatus of claim 1, further comprising a charging and/or AC/DC adaptor plug, for charging and/or powering the advertising apparatus.

12. An advertising apparatus capable of motion sensitive illumination and 180° viewing, the advertising apparatus comprising:
a top piece;
a bottom piece;
a back piece adapted for mounting the advertising apparatus to an external structure;
a front display piece adapted for displaying graphics,
wherein the front display piece has a convex shape, and
wherein the top piece, the bottom piece, the back piece, and the front display piece are mechanically coupled together;
an illumination source for illuminating the front display piece
wherein the front display piece is edge illuminated when the illumination source is active;
a multifaceted motion sensor for detecting motion of a person,
wherein the multifaceted motion sensor is configured to trigger the illumination source when a person's heat moves across at least two facets of the multifaceted motion sensor;
a wireless transmitter,
wherein the wireless transmitter has a transmission radius,
wherein the wireless transmitter is capable of detecting a wireless-enabled device carried by said person when said person passes within the transmission radius of the wireless transmitter, and
wherein the wireless transmitter delivers advertising and marketing content to said wireless-enabled device;
a power source to power the advertising apparatus, wherein the illumination source, and the motion sensor are coupled to the power source; and
a controller for the illumination source coupled to the power source and the illumination source.

13. The advertising apparatus of claim 12, wherein the illumination source is a set of light emitting diodes (LED) placed proximate to an edge of the bottom piece and capable of edge illumination of the front display piece.

14. The advertising apparatus of claim 13, wherein the LEDs are present in at least one LED strip.

15. The advertising apparatus of claim 14, wherein each of the at least one LED strips further comprises twelve LEDs.

16. The advertising apparatus of claim 12, wherein the illumination source is an electroluminescence (EL) light source.

17. The advertising apparatus of claim 16, wherein the front display piece is the EL light source.

18. An advertising apparatus capable of motion sensitive illumination and 180° viewing, the advertising apparatus comprising:
a top piece;
a bottom piece;
a back piece adapted for mounting the advertising apparatus to an external structure;
a front display piece adapted for displaying graphics,
wherein the front display piece has a convex shape, and
wherein the top piece, the bottom piece, the back piece, and the front display surface piece are mechanically coupled together;
an illumination source for illuminating the front display piece wherein the front display piece is edge illuminated when the illumination source is active;
a multifaceted motion sensor for detecting motion of a person,
wherein the multifaceted motion sensor is configured to trigger the illumination source when a person's heat moves across at least two facets of the multifaceted motion sensor;
a wireless transmitter,
wherein the wireless transmitter has a transmission radius,
wherein the wireless transmitter is capable of detecting a wireless-enabled device carried by said person when said person passes within the transmission radius of the wireless transmitter, and
wherein the wireless transmitter delivers advertising and marketing content to said person's wireless-enabled device;
a power source to power the advertising apparatus, wherein the illumination source and the motion sensor are coupled to the power source;
a circuit board comprising a circuit and a controller for the illumination source,
wherein the illumination source, the controller for the illumination source, the motion sensor, the wireless transmitter, and the power source are coupled to the circuit.

19. The advertising apparatus of claim 18, wherein the circuit is configured to have a powered-on period and a powered-off period, wherein the powered-on period is from about 1 second to about 120 seconds and the powered-off period is from about 1 second to about 120 seconds.

20. The advertising apparatus of claim 19, wherein the powered-on period is about 7 seconds and the powered-off period is about 20 seconds.
